(19) United States
(12) Patent Application Publication
(10) Pub. No.: US 2015/0273434 A1
(43) Pub. Date: Oct. 1, 2015

(54) METHOD FOR BINDING THE RESIDUAL MOISTURE IN THE RESIDUE SALT OF A SALT DUMP

(71) Applicant: K+S Kali GmbH, Kassel (DE)

(72) Inventors: Hans-Joachim Kind, Hohenwarthe (DE); Albrecht Palm, Garlipp (DE); Martin Westphal, Wolmirstedt (DE)

(21) Appl. No.: 14/735,378

(22) Filed: Jun. 10, 2015

Related U.S. Application Data
(62) Division of application No. 13/700,409, filed on Jan. 25, 2013.

(30) Foreign Application Priority Data
May 27, 2010 (DE) DE102010021675.5

(51) Int. Cl. B01J 20/28; B01J 20/04; B01J 20/10

(52) U.S. Cl. CPC B01J 20/28011; B01J 20/103; B01J 20/041

(57) ABSTRACT

The invention provides an additive for binding the residual moisture in the residue salt of a salt heap to reduce the heap water content, wherein the additive has hydraulically and/or pozzolanically setting properties.

### CROSS-REFERENCE TO RELATED APPLICATIONS

This application is a divisional of U.S. patent application Ser. No. 13/700,409 filed Jan. 25, 2013, which is the National Stage of International Patent Application Serial No. PCT/DE2011/001125 filed May 20, 2011, which claims priority to German Patent Application No. DE 10 2010 021 675.5 filed May 27, 2010, all of which are incorporated herein by reference in their entireties.

### FIELD OF THE INVENTION

The present disclosure relates to an additive for binding the residual moisture in the residue salt of a salt dump in order to reduce the dump water content, as well as a method for binding the residual moisture in the residue salt and the use of an additive for binding the residual moisture.

### BACKGROUND OF THE INVENTION

During processing of raw salts, for instance for potash production, residues accumulate, which consist substantially of salt. Unless it is disposed of in another manner, this residue is dumped. In order to occupy as little ground area as possible and to expose as little surface as possible in relation to the volume of the dump to precipitations, the dumps are preferably built in the shape of a truncated cone with steep slopes. Many dumps have a seal at their base in order to prevent the pile waste water from seeping away into the ground. The dumps are usually bordered by ditches in order to receive and discharge the accumulating pile water in an orderly fashion, the amount of pile water depending i.a. on the amount of precipitation. The amount of accumulating pile water must be kept as small as possible. In this respect, different methods for covering dumps for the purpose of grassing-over and land reclamation are already known from the prior art. The whole purpose of such a covering is to always provide a steady covering with a great variety of materials that prevents as much as possible precipitation water from penetrating into the body of the dump, thereby causing dissolution processes and forming the pile water. It is known from DE-PS 3925953, DE-OS 4117270 and from DE-PS 4337730 to cover such a salt dump, in order to reduce or completely inhibit the infiltration of precipitation water into the dump.

In this context, the DE-PS 19632154 also describes a dump covering consisting of hydraulically and/or pozzolanically setted mixtures of mineral residue. The residue more specifically comprises ashes from the combustion of sludge, biomass and wood and/or gypseous residues. These mixtures of materials are applied in several layers onto the surface of the dump in the form of a moistened mass starting at the foot of the dump and compacted toward the inner side of the dump.

A dump covering for dumps of residue salt is moreover known from DE 199 37 270 A1 in which a rolling, crumbly green granulate is applied on the dump, the green granulate comprising saline slags from aluminum production as well as hardenable power plant ashes.

As can be gathered from the previously mentioned prior art, this prior art exclusively addresses the matter of keeping precipitation water that falls onto the dump from infiltrating into the dump in order to be able to reduce the dump water content due to precipitation water. However, the residual moisture content of the residue salt is not taken into account. The residue moisture content depends on the respective preceding treatment process. The fundamental methods are electrostatic separation as a “dry” method as well as flotation and hot dissolution, wherein the two latter methods lead to different residual moisture contents in the residue salt. The residual moisture content of residue salt to be dumped should amount to approximately 7%. The reasons for a residual moisture content in this order of magnitude are the required geo-mechanical properties on the one hand and on the other hand the fact that the transport of dust must be avoided during deposition onto the dump. In this respect, the residue salt from the electrostatic separation is correspondingly moistened. Of these 7% of residual moisture, approximately 3% are crystalline-bonded, which means that approximately 4% form free residual moisture that leaves the dump due to gravitation and contributes to a great extent to the dump water content. Assuming that about 10 million tons of residue salt are dumped onto the residue salt dump every year, this results in a dump water content of approximately 300'000 cubic meters per year on the sole basis of the residual moisture. Hereby, it must be taken into account that the dump water accumulates as a saturated solution and has a density of ca. 1.2 gr/cm³.

### DETAILED DESCRIPTION OF THE INVENTION

The object underlying the invention is therefore to minimize and if necessary completely inhibit the accumulation of dump water due to the residual moisture in the salt.

In order to solve the object, the invention proposes to add an additive to the residue salt for binding the residual moisture, the additive having hydraulically and/or pozzolanically setting properties. In this context, it has been seen that by adding 0.2 to 4, preferably 0.5 to 1 mass percent of the additive with hydraulically and/or pozzolanically setting properties, the residual moisture content in the residue salt can be substantially completely bound. This means that for example 1 kg of brown coal filter ashes can bind between 100 ml and 3 1 of water depending on their free lime content, which is specific to their origin. In order to bind the residual moisture of 10 million tons of residue salt, merely 100 000 tons of ash would therefore be required.

As a matter of principle, other possibilities for reducing the dump water content due to the residual moisture in the residue salt are of course available. It would be possible for example to dry the salt before dumping. However, the considerable energy demand on the one hand and the fact that applying dried salt onto the salt dump raises a considerable amount of dust on the other hand argue against this. The consequence of this would be that the salt would be spread by the wind in a wide surrounding area.

Advantageous features can be gathered from the disclosure hereinbelow.

It is for instance more specifically provided that the additive be provided in a mainly silty form. As has already been explained elsewhere, ashes from the combustion of fossil fuels, more specifically of the combustion of brown coal, as well as residues from the processing of substances in heat treatment and combustion processes are more specifically used. As the case may be, mixtures of additives of the previously mentioned components can also be used.

The use of an additive as previously described with hydraulically and/or pozzolanically setting properties for binding the residual moisture in the residual salt of a salt dump is also an object of the invention.

Another object of the invention is a method for binding the residual moisture in the residual salt of a salt dump to reduce the dump water content, characterized in that the residual salt is mixed with an additive with hydraulically and/or pozzolanically setting properties before deposition on the salt dup. Hereby, the mixture can occur during the dumping process, namely in detail by adding the corresponding amount of additive to the residual salt transported on the conveyor belt, the actual intensive mixing of the additive and the residual salt occurring when the mixture passes from one conveyor belt to the next.

To sum up, the advantages are again presented in the following:

First, by adding the additive to the residual salt, the geo-mechanical properties of the residue are not changed. This means more specifically that the slope angle does not change. In addition, a crystalline binding of the residual moisture occurs during mixing of the residual salt with the additive due to the hydraulically and/or pozzolanically setting properties. The general reaction equation is for this is:

Ca(OH)₂+SiO₂+H₂O→CaO×SiO₂+H₂O

1. A method for binding the residual moisture in the residual salt of a salt dump to reduce the dump water content, said method comprising the step of: mixing an additive having hydraulically and/or pozzolanically setting properties into at least a portion of said residual salt prior to said residual salt being placed in said dump.

2. The method of claim 1, wherein the additive has a silty form.

3. The method of claim 1, wherein said additive comprises ash obtained from the combustion of a fossil fuel.

4. The method of claim 1, wherein said additive comprises a substance derived from the heat treatment of a material.

5. The method of claim 1, wherein the proportion of the additive relative to the amount of said residual salt with which it is mixed is in the range of 0.2 to 4 mass percent.

6. The method of claim 1, wherein the proportion of the additive relative to the amount of said residual salt with which it is mixed is in the range of 0.5 to 1 mass percent.

7. The method of claim 1, wherein said additive is mixed with said residual salt while said residual salt is being conveyed to said dump.
